(19) United States
(12) Patent Application Publication
(10) Pub. No.: US 2008/0170475 A1
(43) Pub. Date: Jul. 17, 2008

(54) 20-SECOND/100-SECOND LACROSSE TIMER

(76) Inventor: Gregory R. Simon, Mill Valley, CA (US)

Correspondence Address: BEESON SKINNER BEVERLY LLP, ONE KAISER PLAZA, SUITE 750, OAKLAND, CA, 94612, US

(21) Appl. No.: 12/013,267

(22) Filed: Jan. 11, 2008

Related U.S. Application Data
(60) Provisional application No. 60/880,093, filed on Jan. 12, 2007.

(51) Int. Cl. G04F 8/00

(52) U.S. Cl. 368/109

(57) ABSTRACT

A timing apparatus 10 for monitoring a sports event such as a lacrosse game, comprises a first timer 12 for counting a twenty-second time period and a second timer 14 for counting a one-hundred second time period, an alarm 16 connected to the first and second timers for producing a perceptible warning at the expiration of either of the twenty-second and one-hundred second time periods, and a toggle switch 20 movable between a first position 28 for activating the first timer 12 and a second position 30 for activating the second timer 14.

### CROSS-REFERENCE TO RELATED APPLICATION

This non-provisional patent application claims the benefit of U.S. Provisional Application Ser. No. 60/880,093 filed on Jan. 12, 2007.

### FIELD OF THE INVENTION

This invention is directed to a lacrosse timer, particularly one including a toggle switch permitting selection of either a 20-second timer or a 100-second timer, each of which activates an alarm.

### BACKGROUND

Lacrosse is a contact game played by ten players on each team, the object being to shoot a ball into the opponent's goal. Play is governed by rules promulgated by U.S. Lacrosse, Inc. (the “Rules”). The game is played for four periods; the first and second period constituting the first half of the game and the third and fourth periods constituting the second half of the game. There is a 2-minute break between the first and second periods, and another 2-minute break between the third and fourth periods. There is a 10-minute break between the first and second half of the game, that is, between the end of the second period and the beginning of the third period of the game. Each team is permitted two time-outs for use during each half. Rule 6 governing Illegal Procedure provides in part as follows:
SECTION 6. Any action on the part of players or substitutes of a technical nature that is not in conformity with the rules and regulations governing the play of the game shall be termed illegal procedure. The following are examples:
. . .
f. Delaying the game . . . Delaying the game shall be the consuming of more than 20 seconds:
   1. At the start of the game or a period, 20 seconds to begin when the official blows the whistle to summon the players to position 20 seconds before the official game time; or after one minute and 40 seconds have elapsed between the first and second or third and fourth periods, or after nine minutes and 40 seconds have elapsed between the second and third periods.
   2. After the expiration of a timeout, 20 seconds to begin when the official blows the whistle to summon the players to position after one minute and 40 seconds of a team's charged timeout; or after an injured player has been removed from the game, or whenever play is ready to be resumed after an official's suspension of play.
. . .
Note 1: To enforce strictly the provisions of this rule and to move the game along at a fast pace, each official must carry a timing device and ensure that there are no delays of the game without resulting penalties. If both teams are guilty of delay of the game simultaneously, the official shall consider such breaches grounds to warn both benches that any future such conduct will lead to unsportsmanlike penalties.
Note 2: The official responsible for initiating the 20 seconds to start shall do so by giving an arm signal (raising an arm clearly over the head and then dropping the arm) and using the timing device to immediately start to time 20 seconds.

In light of the above rules, traditionally, at the beginning of one of the 2-minute breaks between periods, or at the beginning of a 2-minute time-out, the official responsible for monitoring time has checked his or her watch and waited until 20-seconds before expiration of the 2-minute period. At that time the official has activated a 20-second timer at the end of which an alarm sounds to indicate a delay of game. If play resumes before the end of the 20-second interval, the official shuts off the timer so that the alarm will not sound. Accordingly, this has required officials to coordinate a watch or other time piece with the 20-second timer. This results in unwanted juggling between two devices and injects an undesirable degree of inaccuracy into the 2-minute period. 20-second timer devices are well known in the lacrosse community and are commonly used. However, one disadvantage to a prior art 20-second timer frequently used is that it is attached by threading one's waist belt through two elastic bands affixed to the timer. Thus, each time an official puts on one of the prior art timers, he or she must remove his or her waist belt to attach the timer. Another disadvantage to the prior art 20-second timer is that it is an analog device which, while being adjustable, is vulnerable to measurement errors.

### BRIEF DESCRIPTION OF THE ILLUSTRATIONS

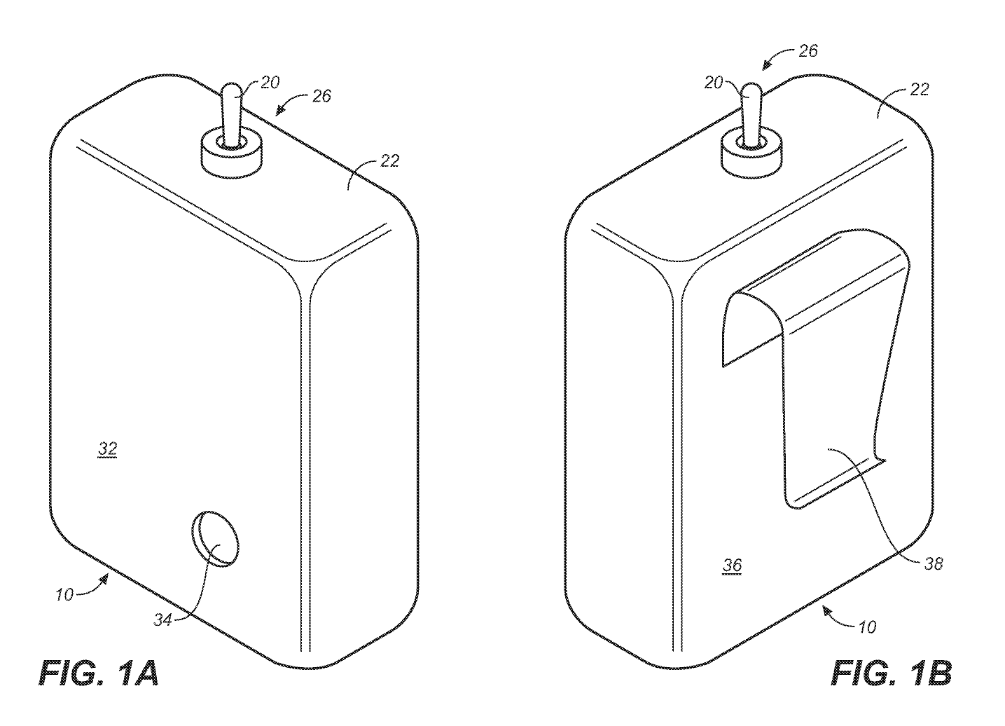

FIG. 1A is a front perspective view of a 20-second/100-second lacrosse timer according to the invention, shown with a switch in the OFF position.

FIG. 1B is a rear perspective view of the 20-second/100-second lacrosse timer shown in FIG. 1A with the switch in the OFF position.

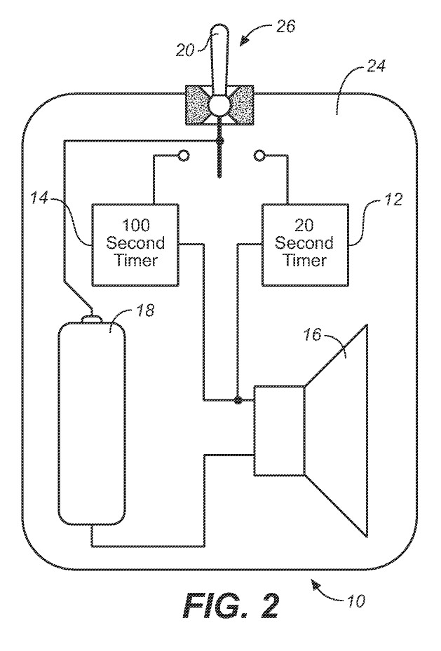

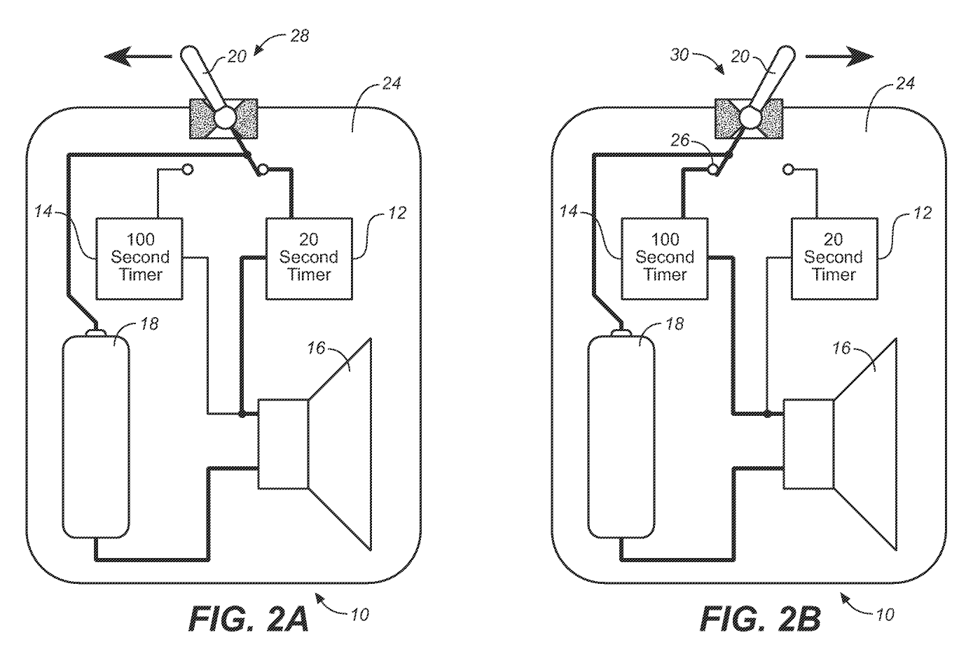

FIG. 2 is a graphical representation of the functional components of the 20-second/100-second lacrosse timer shown in FIGS. 1A and 1B, with the switch in the OFF position.

FIG. 2A is a graphical representation of a circuit activated by the switch shown in the operational position for the 20-second timer.

FIG. 2B is a graphical representation of a circuit activated by the switch shown in the operational position for the 100-second timer.

### DESCRIPTION OF THE ILLUSTRATED EMBODIMENT

A 20-second/100-second lacrosse timer is indicated generally at 10 in FIGS. 1A-2B. The timer comprises a case 22 enclosing a circuit board 24 with circuits connecting a 20-second timer 12 and a 100-second timer 14, to an alarm 16, a power source 18, such as a battery, and a toggle switch 20. The toggle switch 20 has 3 settings: an OFF position 26, as shown in FIGS. 1A, 1B and 2, a first position 28 for activating the 20-second timer 12, as shown in FIG. 2A, and a second position 30 for activating the 100-second timer 14, as shown in FIG. 2B.

In field use, at the commencement of a 2-minute period, the official throws the toggle switch 20 to the second position 30 for activating the 100-second timer 14 position (FIG. 2B). Preferably the toggle switch has a toggle arm similar to that shown in the illustrations. However, the switch could be a rocker switch, or single or dual push buttons, or any other switching mechanism that can be quickly and easily activated in field use by touch. When 100 seconds have elapsed, the timer 14 will send a signal to the alarm 16 causing it to produce a perceptible warning when 100 seconds have elapsed. The perceptible warning may be audible, physical, such as by vibration, or visible, or a combination thereof. The 100-second alarm alerts the official to blow a whistle to commence the 20-second period under Rules 6.f.(1) and (2) to summon the players to position. The official will simultaneously be prompted by the 100-second alarm to throw the toggle switch 20 from the second position 30 for activating the 100-second timer 14 to the first position 28 for activating the 20-second timer 12 (FIG. 2A) to cause the alarm 16 to sound at the expiration of 20 seconds, indicating that a delay-of-game penalty may be in order.

The 20-second/100-second timer 10 conveniently puts both a 20-second timer 12 and a 100-second timer 14 at the immediate disposal of the official in a single integrated mobile device. The ability to sequentially employ the 100-second timer 14 and the 20-second timer 12 eliminates having to coordinate a watch or similar time piece with a separate timer and alarm, and provides greater accuracy in the conduct of a lacrosse game.

Referring to FIG. 1A, the case 22 enclosing the components of the timer 10 includes a front cover 32. An aperture 34 is provided in the front cover 32 near the alarm 16 to allow sound to escape from the case 22. A back cover 36 aligns with the front cover 32 to fully encase the timer components except for the exposed switch 20. As seen in FIG. 1B, a flexible clip 38 is provided on the back cover 36 of the case 22 to allow the official or other user to attach the timer 10 to a waist belt or pants for convenient access during a game.

The preferred embodiment of the invention is constructed using a circuit board 24 which incorporates one or more digital timers. Digital timing devices more accurately measure time intervals than prior art analog devices, are rugged, and can be manufactured inexpensively in small unit sizes.

While a 20-second/100-second timer has been described and illustrated, it will be recognized and appreciated by those skilled in the art that modifications are within the true spirit and scope of the invention. The appended claims are intended to cover all such modifications.

I claim:

1. A timing apparatus for monitoring an athletic endeavor, comprising:
a first timer for counting a twenty-second time period,
a second timer for counting a one-hundred second time period,
an alarm connected to said first and second timers, said alarm producing a perceptible warning at the expiration of either of said twenty-second time period and said one-hundred second time period, and
a toggle switch movable between a first position and a second position, said first position for activating said first timer, and said second position for activating said second timer.

2. An apparatus according to claim 1 wherein:
said first and second timers are digital timers.

3. An apparatus according to claim 1 wherein:
said perceptible warning is audible.

4. An apparatus according to claim 1 wherein:
said perceptible warning is vibratory.

5. An apparatus according to claim 1 wherein:
said perceptible warning is visible.

6. An apparatus according to claim 1 wherein:
said toggle switch has an off position.

7. An apparatus according to claim 6 wherein:
said off position is between said first and second positions.

8. An apparatus according to claim 1 further comprising:
a circuit board including circuits to operate said first timer, said second timer, and said alarm.

9. An apparatus according to claim 8 further comprising:
a power source to supply power to said circuit board to activate said circuits.

10. An apparatus according to claim 9 wherein:
said power source is a battery.

11. An apparatus according to claim 1 further comprising:
a case for enclosing said first and second timers and said alarm.

12. An apparatus according to claim 11 wherein:
said case is provided with at least one aperture to emit sound from said alarm.

13. An apparatus according to claim 11 wherein:
said case has a back cover and a flexible clip extending from said back cover for attaching said apparatus to an object.

14. A timing apparatus for monitoring an athletic endeavor, comprising:
a circuit board having a first timer circuit for counting a twenty-second time period, a second timer circuit for counting a one-hundred second time period, and an alarm connected to said first and second timers, said alarm producing an audible warning at the expiration of either of said twenty-second time period and said one-hundred second time period,
a toggle switch movable between an off position, a first position, and a second position, said first position for activating said first timer circuit, and said second position for activating said second timer circuit,
a power supply to activate said circuits, and
a case enclosing said first and second timer circuits, said alarm, and said power supply, said case provided with at least one aperture to emit a sound from said alarm.
